(19) United States
(12) Patent Application Publication
(10) Pub. No.: US 2005/0129110 A1
(43) Pub. Date: Jun. 16, 2005

(54) Coding and decoding method and device

(76) Inventors: Gwenaelle Marquant, Liffre (FR); Joel Jung, Guyancourt (FR)

Correspondence Address: PHILIPS INTELLECTUAL PROPERTY & STANDARDS, P.O. BOX 3001, BRIARCLIFF MANOR, NY, 10510, US

(21) Appl. No.: 10/510,295

(22) PCT Filed: Apr. 3, 2003
(86) PCT No.: PCT/IB03/01371

(30) Foreign Application Priority Data
Apr. 12, 2002 (EP) 02290934.5

(51) Int. Cl. H04N 7/12

(52) U.S. Cl. 375/240.03; 375/240.18

(57) ABSTRACT

The invention relates to a method of coding an input digital video sequence corresponding to an original color image sequence, said method comprising at least a step for converting said video sequence from the spatial domain to less representation data, a quantization step, for transforming the converted signals thus obtained into a reduced set of data. According to the invention, said coding method also comprises, before said converting step, a pre-processing step, provided for determining if the input video sequence is in YUV color space, Y being the luminance component and U, V the chrominance components, and transforming said space into a less redundant color space by means of a non-linear transformation taking into account the possible lower quality finally obtained.

### FIELD OF THE INVENTION

The present invention generally relates to video compression and, more particularly, to a method of coding an input digital video sequence corresponding to an original color image sequence, said method comprising at least the following steps:
(1) a converting step, provided for converting said video sequence from the original spatial representation domain to less representation data (for example, such as used in transform coding, mesh-based coding, predictive coding, etc.);
(2) a quantization step, provided for transforming the converted signals thus obtained into a reduced set of data;
(3) an encoding step, provided for coding said reduced set of data.

The invention also relates to a corresponding encoder, to a method of decoding signals coded by means of said coding method, to a corresponding decoder, and to systems comprising computer readable program codes for implementing said coding and decoding methods.

### BACKGROUND OF THE INVENTION

Data compression systems generally operate on an original data stream by exploiting the redundancies in the data, in order to reduce the size of said data to a compressed format more adapted to a transmission or storing operation. For these data, several color spaces may be used (a color space is completely parametrized with three colors linearly independent), and for instance the red-green-blue (RGB) color space (which is still severely redundant) or the so-called opponent color space, nominally white/black (or WB), red/green (or RG) and blue/yellow (or BY), or, in the video case, the YUV space.

In classical video approaches, the video is often encoded along the three following separate channels: luminance Y, component U of chrominance, component V of chrominance. As it seems difficult, with this classical (Y, U, V) representation scheme, to highly improve the rate/distorsion ratio, it has been proposed in the european patent application n^{o} 02290484.1 filed on Feb. 28, 2002, by the applicant (PHFR020014) to change the representation space in order to achieve a higher coding efficiency (for example in order to encode more information with the same bit budget, or less information with far less bits). The coding method described in said document mainly comprises, before the coding step, a pre-processing step, provided for verifying in which color space the input video sequence is and transforming said space into a less redundant one by means of a non linear transformation. However, less information may lead to a lower quality.

### SUMMARY OF THE INVENTION

It is therefore a first object of the invention to propose another encoding method for the compression of a digital color video sequence, allowing to transform the original color space of said sequence into a less redundant one, by means of a non-linear transformation taking into account the possible lower quality finally obtained.

To this end, the invention relates to a coding method such as defined in the introductory part of the description and which is moreover characterized in that it also comprises, before said converting step, a pre-processing step, provided for determining if the color space of the input video sequence is the YUV color space, where Y is the luminance component and U, V the chrominance components, and transforming said YUV color space into a less redundant color space by means of a non-linear transformation taking into account the possible lower quality finally obtained.

By coding with a greater precision all the relevant part of the information, whereas non-relevant information may be degraded, a better coding efficiency is obtained.

### BRIEF DESCRIPTION OF THE DRAWINGS

The invention will now be described in a more detailed manner, with reference to the accompanying drawings in which:

FIG. 1 illustrates an uniform luminance dynamic compression (the X-axis corresponds to the original luminance values and the Y-axis to the new ones, as obtained after compression);

FIG. 2 illustrates an example of perceptual dynamic compression according to the invention, with similar axes;

FIG. 3 illustrates the case of different ratios for the luminance compression, according to the concerned range;

FIG. 4 illustrates the case of an adaptive and piecewise continuous compression for the side ranges;

FIG. 5 illustrates how the original luminance values can be clustered outside the central range;

FIGS. 6 and 7 depict respectively a coding device and decoding device according to the invention.

### DETAILED DESCRIPTION OF THE INVENTION

Considering that, for a wide range of applications (such as digital movies, high-definition television, transmission or visualization of scientific imagery, . . . ), the ultimate consumer is the human eye, the basic idea of the invention consists in choosing a representation based upon the partition of the visual signals by the early human visual system, i.e. in designing the image codes in such a way that they match the visual capacities of the human observer.

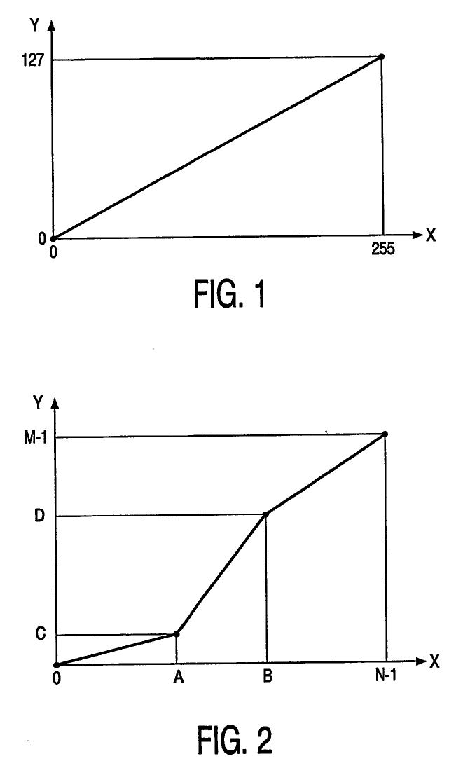

Perceptual studies have already shown that, under standard viewing conditions, human eyes cannot distinguish small luminance variations (from 1 to 5 grey levels). A common approach has then consisted in uniformly compressing the luminance dynamic by using less grey levels, which is for instance illustrated in FIG. 1 where 128 luminance grey levels are used instead of 256 ones (which is equivalent to a 7 bits luminance coding). Tests have shown that, if this luminance dynamic compression followed by the inverse transform are applied to an image, human eyes cannot detect any variation between the original image and the reconstructed one.

According to the invention, it is then proposed to adaptively compress the luminance dynamic. Perceptual tests performed by the applicant show that, for a luminance dynamic including 256 grey levels (from 0 to 255 for example), human eyes are more sensitive to luminance changes inside the luminance range [70;130] than in the range [0;70] or in the range [130;255]. More generally, the applicant has considered that, for a luminance dynamic including N grey levels (from 0 to N-1 for example), a more relevant information is the one located in a central range [A;B] and a less relevant information is located in the side ranges [0;A] and [B;N-1].

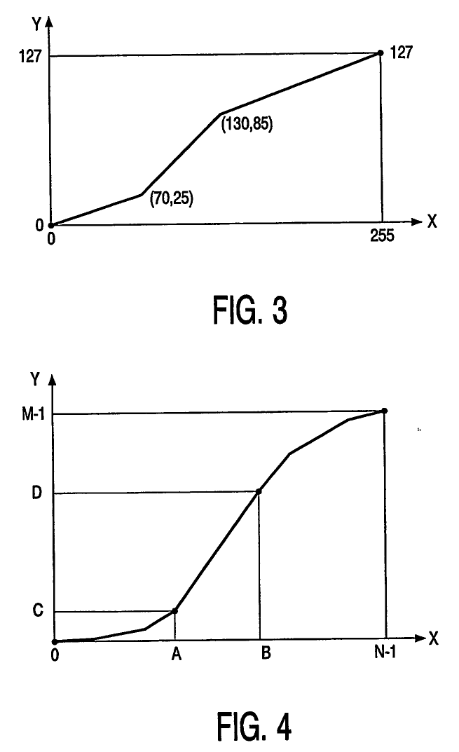

In order to exploit this property of a variable perception according to the considered luminance ranges, it is then proposed, given an original luminance range of N grey levels (for example from 0 to N-1 as illustrated in FIG. 2) and, according to the uniform luminance dynamic compression illustrated in FIG. 1, a corresponding output luminance range of M grey levels (for example from 0 to M-1 as shown in FIG. 2), with M lower than N, to keep unchanged the luminance dynamic inside the central range [A;B] and to compress the luminance outside said central range, as shown in FIG. 2. As seen above, tests performed by the applicant show that A=70 and B=130 are the values preferably chosen (for N=256). For instance, in the example illustrated in FIG. 3, the luminance dynamic is kept unchanged between 70 and 130, whereas a compression ratio of 2 is used outside this range, between 0 and 70 and between 130 and 255.

Practically, several compression modes may be proposed. In the example of FIG. 2, the compression in the side ranges is uniform, but other solutions are possible. As illustrated in FIG. 4, the compression may also be adaptive and piecewise continuous outside the central range. In this manner, the luminance compression is progressively lessened from 0 to A and from N-1 to B. For instance, simple affine functions (three in FIG. 4) may be used, but also more complex functions (such as sigmoid functions) are possible. An alternative solution may be to use different ratios for the values in the central range and the values outside it. For example, a ratio of 2 may be used in the central range [70,130] and a higher ratio in the side ranges [0,70] and [130,255], for a compression from 256 grey levels to 64 ones (i.e with 6 bits).

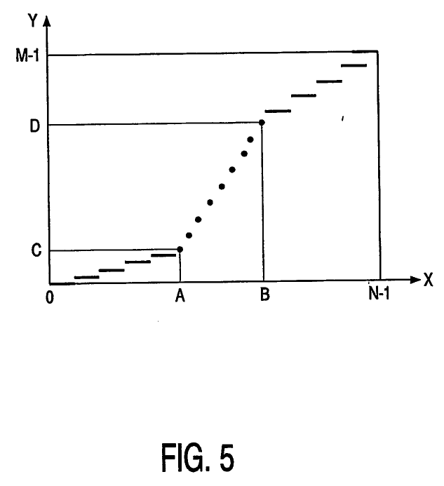

It may also be noticed that, because only M integer values are used after the dynamic compression, once the luminance transformation is performed, more precise values are used for original values inside the central range (between A and B), whereas outside said central range many original values are clustered (as depicted in FIG. 5) in a single one (and clustered values can in turn be clustered in order to further increase the dynamic compression in anyone of the side ranges, or both).

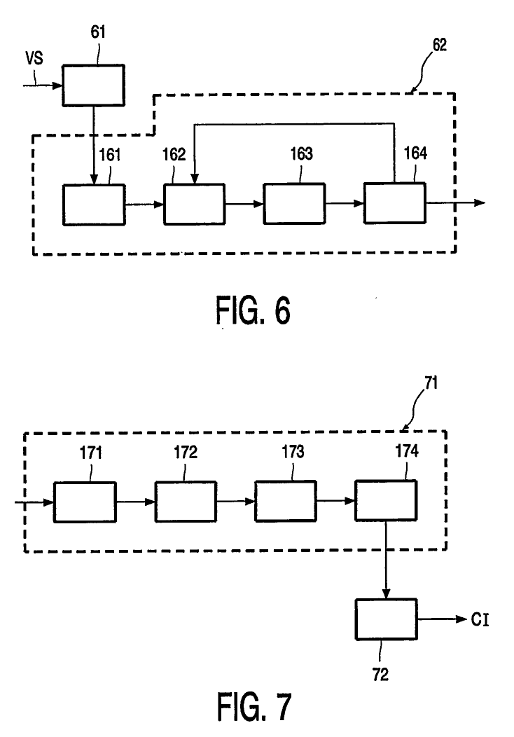

An embodiment of a coding device for the implementation of the coding method according to the invention is now described. As shown in FIG. 6, the video sequence (video signal VS) is first presented to a preprocessor 61, the output of which is received by an encoder 62. The data contained in the input video signal include pixel values which describe the color components (luminance signal Y, color difference signals U and V) of a corresponding location in the original images to which the video sequence corresponds. The encoder 62 comprises for instance a DCT (discrete cosine transform) transform circuit 161, which linearly transforms blocks of 8×8 pixels into the frequency domain, a quantizer 162, that receives the DCT coefficients thus obtained and performs their quantization, a variable length coder 163, that carries out the coding step of the quantized coefficients, and a rate controller 164, that stores the output signal of the coder 163 and sends to the quantizer 162 a feedback signal allowing to modify the quantization setting (such a rate controller generally comprises a buffer for receiving the coded bitstream and an update circuit for generating an updated quantization setting). The preprocessor 61 is provided for changing the representation space (Y, U, V) into the new space.

At the decoding side, a decoding device is provided for implementing the above-mentioned inverse transformation and comprises, as shown in FIG. 7, a decoder 71 followed by a postprocessor 72 carrying out the inverse transformation allowing to recover the true color image CI. Said decoder, that receives the bitstream coded by means of the coding device described above, usually comprises a variable length decoder 171, an inverse quantization circuit 172, an inverse DCT circuit 173, and a reconstruction circuit 174.

The encoding and decoding devices, (61, 62) and (71, 72) respectively, can be implemented in a variety of ways to perform the functionalities described herein. In one embodiment, they may be embodied as software stored on media and executed by a general purpose or specifically configured computer system, typically including a central processing unit, memory and one or more input/output devices and processors. Alternatively, they may be implemented as a combination of hardware, software or firmware, without excluding that a single item of hardware or software can carry out several functions or that an assembly of items of hardware or software or both carry out a single function. The described methods and devices may be implemented by any type of computer system or other apparatus adapted for carrying out the methods described herein, this computer system including a computer program that, when loaded and executed, controls the computer system such that it carries out the methods described herein.

Alternatively, a specific use computer, containing specialized hardware for carrying out one or more of the functional tasks of the invention, can be utilized. The present invention can also be embedded in a computer program product, which comprises all the features enabling the implementation of the methods and functions described herein, and which—when loaded in a computer system—is able to carry out these methods and functions. Computer program, software program, program, program product, or software, in the present context mean any expression, in any language, code or notation, of a set of instructions intended to cause a system having an information processing capability to perform a particular function either directly or after either or both of the following: (a) conversion to another language, code or notation; and/or (b) reproduction in a different material form.

1. A method of coding an input digital video sequence corresponding to an original color image sequence, said method comprising at least the following steps:
(1) a converting step, provided for converting said video sequence from the original spatial representation domain to less representation data;
(2) a quantization step, provided for transforming the converted signals thus obtained into a reduced set of data;
(3) an encoding step, provided for coding said reduced set of data
said coding method being further characterized in that it also comprises:
(4) before said converting step, a pre-processing step, provided for determining if the color space of the input video sequence is the YUV color space, where Y is the luminance component and U, V the chrominance components, and transforming said YUV color space into a less redundant color space by means of a non-linear transformation taking into account the possible lower quality finally obtained.

2. A coding method according to claim 1, in which said pre-processing step is an operation consisting in compressing the luminance dynamic by using a number M of grey levels lower than the original number N before said compression operation, said compression operation being characterized in that said luminance dynamic of N grey levels is divided into a central range [A;B] and two side ranges [0;A] and [B;N-1], and the original side ranges [0;A], [B;N-1] are transformed by means of the compression operation into transformed side ranges [0;C], [D;M-1], with [0;C] lower than [0;A] and [D;M-1] lower than [B;N-1], the original central range [A;B] being kept unchanged.

3. A coding method according to claim 2, characterized in that the
compression in said side ranges is uniform.

4. A coding method according to claim 1, in which said pre-processing step is
an operation consisting in compressing the luminance dynamic by using a number M of grey levels lower than the original number N before said compression operation, said compression operation being characterized in that said luminance dynamic of N grey levels is divided into a central range [A;B] and two side ranges [0;A] and [B;N-1], and the original central range [A;B] and side ranges [0;A] [B;N-1] are transformed by means of the compression operation respectively into a transformed central range
[C;D] and into transformed side ranges [0;C], [D,M-1], with [0; C] lower than
[0;A], [C;D] lower than [A;B] and [D;M-1] lower than [B;N-1], the compression
ratio applied to the original central range [A;B] being lower than the one applied to
the original side ranges.

5. A coding method according to claim 4, characterized in that the compression ratio in said central and side ranges is uniform.

6. A coding method according to claim 2, characterized in that the compression in said side ranges is adaptive and piecewise continuous, the luminance compression being progressively lessened in the part of each of said side ranges which is contiguous to the central range.

7. A coding method according to claim 6, characterized in that one or several affine functions are used for the progressive lessening of the luminance compression in said contiguous parts.

8. A coding method according to claim 6, characterized in that sigmoid functions are used for the progressive lessening of the luminance compression in said contiguous parts.

9. A coding method according to claim 5, characterized in that, after the luminance dynamic compression, some transformed values are still clustered in the side ranges, in view of a further dynamic compression in said ranges.

10. A device for coding an input digital video sequence corresponding to an original color image sequence, said device comprising at least:
(1) converting means for converting said video sequence from the original spatial representation domain to less representation data;
(2) quantization means for transforming the converted signals thus obtained into a reduced set of data;
(3) encoding means for coding said reduced set of data said coding device being further characterized in that it also comprises:
(4) before said converting means, pre-processing means for determining if the color space of the input video sequence is the YUV color space, where Y is the luminance component and U, V the chrominance components, and transforming said YUV color space into a less redundant color space by means of a non-linear transformation taking into account the possible lower quality finally obtained.

11. A coding device according to claim 10, in which said pre-processing means are a compression stage in which the luminance dynamic is reduced by using a number M of grey levels lower than the original number N before compression, said luminance dynamic of N grey levels being divided into a central range [A;B] and two side ranges [0;A] and [B;N-1], the original side ranges [0;A], [B;N-1] being transformed by means of the compression operation into transformed side ranges [0;C], [D;M-1], with [0;C] lower than [0;A] and [D;M-1] lower than [B;N-1], and the original central range [A;B] being kept unchanged.

12. A coding device according to claim 10, in which said pre-processing means are a compression stage in which the luminance dynamic is reduced by using a number M of grey levels lower than the original number N before compression, the compression operation being such that said luminance dynamic of N grey levels is divided into a central range [A;B] and two side ranges [0;A] and [B;N-1], and the original central range [A;B] and side ranges [0;A] [B;N-1] are transformed by means of the compression operation respectively into a transformed central range
[C;D] and into transformed side ranges [0;C], [D,M-1], with [0;C] lower than
[0;A], [C;D] lower than [A;B] and [D;M-1] lower than [B;N-1], the compression
ratio applied to the original central range [A;B] being lower than the one applied to
the original side ranges.

13. A system comprising a computer usable medium having computer readable program code means embodied therein for implementing a digital video coding device provided for coding an input digital video sequence corresponding to an original color image sequence, said computer readable program code means comprising the following computer readable program codes:
a program code for causing said computer to detect if the color space of the input color video sequence is the YUV color space, where Y is the luminance component and U, V the chrominance components, and to transform said YUV color space into a less redundant color space;
a program code for causing said computer to convert said transformed sequence from the original spatial representation domain to a new representation domain with less representation data;
a program code for causing said computer to perform a quantization of said converted sequence;
a program code for causing said computer to encode the quantized data thus obtained.

14. A method of decoding signals coded by means of a coding method applied to an input digital video sequence itself corresponding to an original color image sequence, said coding method comprising at least the following steps:
(1) a converting step, provided for converting said video sequence from the original spatial representation domain to less representation data;
(2) a quantization step, provided for transforming the converted signals thus obtained into a reduced set of data;
(3) an encoding step, provided for coding said reduced set of data;
(4) before said converting step, a pre-processing step, provided for determining if the color space of the input video sequence is the YUV color space, where Y is the luminance component and U, V the chrominance components, and transforming said YUV color space into a less redundant color space by means of a non-linear transformation taking into account the possible lower quality finally obtained;
said decoding method being characterized in that it comprises the following steps:
(1) a decoding step, provided for decoding said coded signals;
(2) an inverse quantization step, applied to the decoded signals thus obtained;
(3) an inverse converting step, provided for concerting the inverse quantized signals thus obtained to the original spatial representation domain;
(4) a post-processing step, provided for carrying out on the inverse converted signals thus obtained an inverse transformation with respect to the non-linear transformation provided in said pre-processing step.

15. A device for decoding signals by means of a decoding method according to claim 14.

16. A system comprising a computer usable medium having computer readable program code means embodied therein for implementing a digital video decoding method according to claim 14.
